(19) United States
(12) Patent Application Publication
(10) Pub. No.: US 2021/0080058 A1
(43) Pub. Date: Mar. 18, 2021

(54) Joint Structure of High Pressure Grease Gun Tubing

(71) Applicants: CHUN-YI YEH, Taibao City (TW); HAN-CHE YEH, Taibao City (TW)

(72) Inventors: CHUN-YI YEH, Taibao City (TW); HAN-CHE YEH, Taibao City (TW)

(21) Appl. No.: 16/568,335

(22) Filed: Sep. 12, 2019

(51) Int. Cl. F16N 21/04

(52) U.S. Cl. CPC F16N 21/04; F16N 3/12

(57) ABSTRACT

A joint structure of high pressure grease gun tubing is an oil pipe connected to a high pressure grease gun, and the end of the oil pipe is connected with a rotatable joint, and the joint includes a joint connected with the oil pipe for that the grease can pass through the middle through hole, and the end of the joint is sequentially provided with a first shaft part, a second shaft part with an outer diameter slightly larger than the first shaft part and a caulking groove for the oil sealing washer and the oil sealing ring to be sleeved, and a rotary joint has the thread on the outside end and the grease can pass in its middle. The inside end of the rotary joint is embedded into the caulking groove of the joint, and a first coupling part for coupling of the first shaft part is arranged in the middle of the rotary joint, which is closely fitted with the oil sealing ring and the oil sealing washer. A second coupling part for coupling of the second shaft part makes that the rotary joint can be rotated on the joint without falling out, and that it is easier to connect with the grease nozzle of the lubricating grease, and also there is no leakage under the action of high pressure grease.

### BACKGROUND OF INVENTION

### 1. Field of the Invention

The present invention relates generally to a rotary joint which is embedded in the joint of the end of the oil pipe on the high pressure grease gun, and an oil sealing washer and an oil sealing ring are arranged between the rotary joint and the joint, so that the rotary joint can be easily connected with the grease nozzle of the grease to be filled, and also it can prevent the leakage of high pressure grease.

### 2. Description of Related Art

General grease gun is widely used in manufacturing, maintenance and dye printing services as well as industrial, agricultural, aviation, marine, dock, construction and other engineering machinery equipment repair and maintenance, wherein the high-pressure grease gun can be used in the lubrication system and the complete grease distribution equipment, also suitable for high viscosity grease, working in cold areas.

The principle of the high pressure grease gun is: as shown in FIGS. 1 and 2, an oil pipe 2 is connected with the grease outlet of the grease gun 1. The end of the oil pipe 2 is connected with a joint 3, and then the joint 3 is screwed on the grease nozzle to be injected with the lubricating grease, and also the grease gun 1 is provided with a grease cylinder 11 that can be filled with lubricating grease, so that when it is guided into the gun through the compressed air via the hose, the air pressure is used to force the triggering of the continuous extrusion mechanism inside the gun, the lubricating grease can be sucked into the gun bore from the grease cylinder 11 and continuously extruded into the grease nozzle from the joint 3 via the oil pipe 2, hereby achieving continuous supply of lubrication grease.

The structure of the joint 3 at the end of the oil pipe 2 includes a joint 3 sleeved with a casing pipe 32, so that the oil pipe 2 is inserted between the joint 3 and the casing pipe 32, and then the two ends of the casing pipe 32 are pressed, so that the two ends of the casing pipe 32 form a tight part 321 to clamp the oil pipe 2 against the joint 3 not to be detached, and the outer end of the joint 3 is provided with a screw thread 31 for that the joint 3 and the grease nozzle are tightly bolted together (oil pipe 2 is the same structure as joint 3 connected to grease gun 1).

Therefore, through the above method of the joint 3 connected with the oil pipe 2, when the extruded grease is pumped to the grease nozzle by the grease gun 1 in a high pressure manner, the lubricating grease will not leak due to the high pressure, but after one end of the oil pipe 2 is screwed on the grease gun 1, the joint 3 at the other end of the oil pipe 2 is connected with the grease nozzle to be filled with the lubricating grease, because the screw thread 31 is a part of the joint 3 self-structure, and the oil pipe 2 is again fixed together with the joint 3, so the joint 3 cannot be rotated on the oil pipe 2. Therefore, when the screw thread 31 is screwed with the grease nozzle, the entire grease gun 1 must be rotated together, so that join the joint 3 can be connected with the grease nozzle, in such a joint 3 structure, the injection operation of the lubricating grease is very inconvenient and troublesome.

### SUMMARY OF THE INVENTION

Thereupon, in order to improve the connection operation between the joint of the oil pipe end of the aforementioned known high pressure grease gun and the grease nozzle to be injected with the lubricating grease, the present invention provides a design of the joint that can be rotated on the oil pipe, that is, the outer end of the joint connected to the oil pipe is provided with a first shaft part and a second shaft part with slightly larger outer diameter, which can be sleeved for the oil sealing washer and the oil sealing ring, and a rotation joint is provided for the oil sealing washer and the oil sealing ring are tightly fitted and the second coupling part fitted with the second shaft part, and then the rotary joint can be fitted on the joint, and then the rotary joint is easily connected with the grease nozzle to be injected with the lubricating grease without rotation together with the grease gun. Also, the seal of the oil sealing washer and the oil sealing ring can prevent the high-pressure lubricating grease leaked from the rotary joint.

The technical solution adopted by the present invention to solve the technical problem is: a joint is connected to the oil pipe, and the joint is provided with a first shaft part and a second shaft part in a sequence from the outside to the inside, so that the first shaft part is sleeved on an oil sealing washer and an oil sealing ring in a sequence, and abutted on the second shaft part, and a rotary joint with a screw thread at an outer end thereof is provided, its inside is provided with a first coupling part and a second coupling part for coupling of a first shaft joint and a second shaft joint, and the oil sealing washer and the oil sealing ring are tightly fitted in the second shaft joint, and then the rotary joint can be fitted on the joint.

In the above solution, a caulking groove is arranged at the inside of the second shaft part on the joint, and a nesting part is arranged at the inside end of the rotary joint, so that the end of the nesting part is pressed and embedded in the caulking groove and the rotary joint is rotated on the joint without falling out.

Therefore, a rotary joint is provided at the end of the joint connected to the oil pipe of the high pressure grease gun, so that the rotary joint can be freely rotated without falling out, and then connected with the grease nozzle to be injected with the lubricating grease. As long as the rotary joint is rotated without the need to rotate together with the grease gun, it can be easily connected with the grease nozzle, so that the connection operation is easier, and also the high-pressure grease will not be leaked from the rotary joint.

### BRIEF DESCRIPTION OF THE DRAWINGS

The present invention will be further described below in conjunction with the accompanying drawings and embodiments.

FIG. 1 is a schematic diagram of the general high pressure grease gun structure.

FIG. 2 is a three-dimensional schematic diagram of the joint at the end of the general high pressure grease gun oil pipe.

FIG. 3 is a three-dimensional schematic diagram of the joint at the end of the oil pipe of the present invention.

FIG. 4 is a three-dimensional decomposition schematic diagram of the joint at the end of the oil pipe of the present invention.

FIG. 5 is a sectional schematic diagram of the joint at the end of the oil pipe of the present invention.

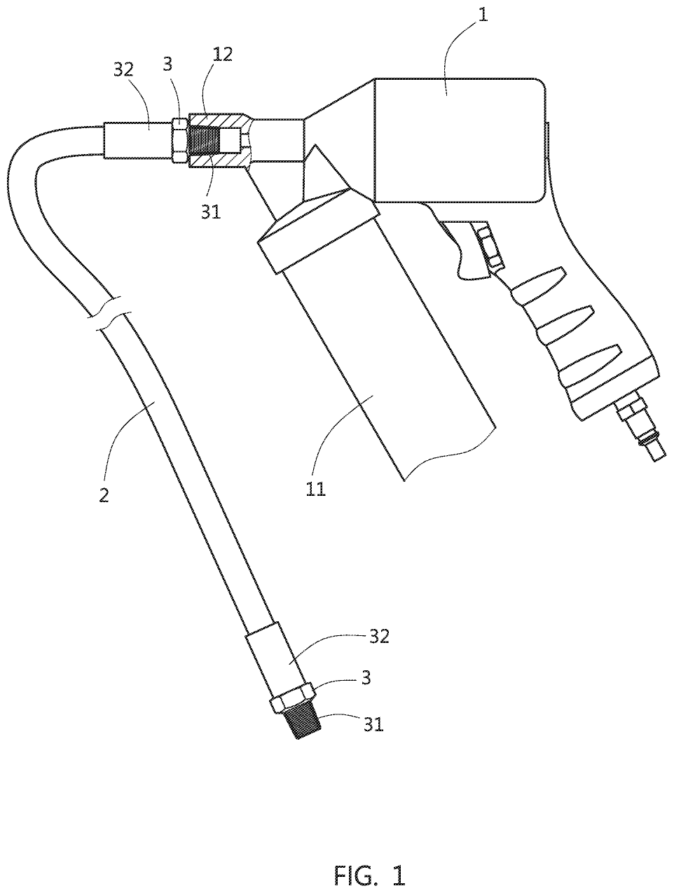

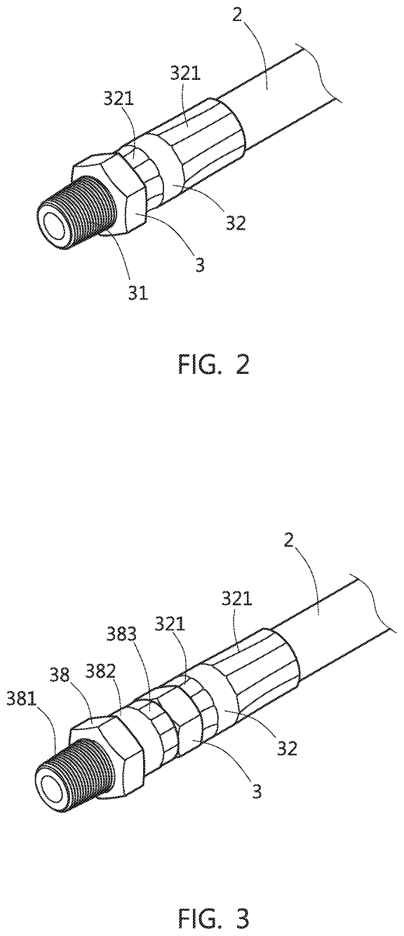

### DETAILED DESCRIPTION OF THE INVENTION

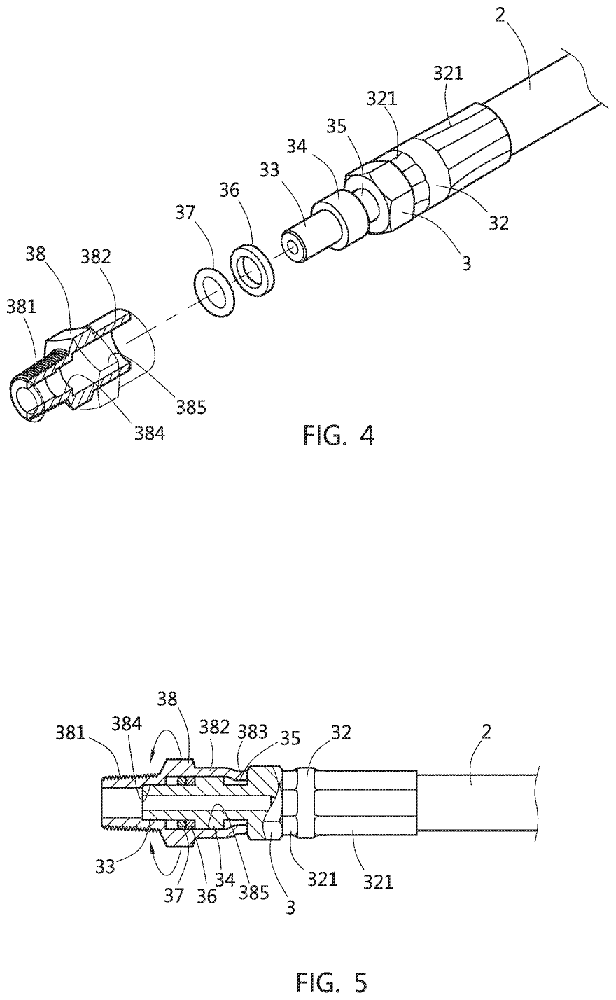

Referring to FIGS. 3 to 5, the end of the oil pipe 2 on the grease gun of the present invention is connected with a joint 3, and the joint 3 is also pressed by the two ends of the casing pipe 32 to form a tight part 321, the pipe 2 is tightly connected between the joint 3 and the casing pipe 32, and the outer end of the joint 3 is sequentially provided with a first shaft part 33 and a second shaft part 34 with an outer diameter slightly larger than the first shaft part 33, and provided with a recessed caulking groove 35, so that an oil sealing washer 36 and an oil sealing ring 37 are sleeved on the first shaft part 33 in a sequence, and abutted on the second shaft part 34.

Further, a rotary joint 38 is provided. The outside end of the rotary joint 38 is provided with a screw thread 381, the inside end is provided with a nesting part 382, and a first coupling part 384 is provided at the middle of the middle through-hole of the rotary joint 38 and a second coupling part 385 is provided at the inside end. Further, the first shaft part 33 of the joint 3 is axially coupled with the first coupling part 384 of the rotary joint 38, and the second shaft part 34 of the joint 3 is axially coupled with the second coupling part 385 of the rotary joint 38, and the oil sealing washer 36 and oil and the sealing ring 37 is fitted into the second coupling part 385. Then, when the rotary joint 38 is sleeved on the joint 3, the end of the nesting part 382 is pressed to form the embedded part 383 embedded in the caulking groove 35 of the joint 3, so that the rotary joint 38 can be rotatably embedded in the joint 3 without falling out; also, the oil sealing washer 36 is made of the wear-resistant material of the Teflon-like type, so that the first shaft part 33 can be fitted closely with the second coupling part 385, and the oil sealing ring 37 is made of the rubber and also the first shaft part 33 can be fitted closely with the second coupling part 385.

Therefore, as long as the rotary joint 38 on the joint 3 at the end of the oil pipe 2 of the grease gun is directly rotated, the rotary joint 38 can be screwed into the grease nozzle to be injected with the lubricating grease, so that the grease gun or the oil pipe 2 does not have to be rotated together, the entire connection operation is easier, and also through the leakage-blocking effect of the oil sealing washer 36 and oil sealing ring 37, the high-pressure lubricating grease will not be leaked from the rotary joint 38, ensuring the smoothly filling operation of the lubricating grease.

Further, when the rotary joint 38 is locked on the grease nozzle and the high pressure grease gun is started, so that the high pressure lubricating grease generated in the oil pipe 2 is injected into the grease nozzle, at this time the high pressure lubricating grease will also entering the second coupling part 385 via the first coupling part 384, the high pressure lubricating grease will push and extrude the oil sealing washer 36 and the oil sealing ring 37, the rotary joint 38 cannot be rotated, so as to ensure that the rotary joint 38 will not be loosened due to the external force when the lubricating grease is filled, and the high safe filling operation the lubricating grease can be achieved.

1. A joint structure of high pressure grease gun tubing is a joint that is connected to an oil pipe; the joint is provided with a first shaft part and a second shaft part in a sequence from the outer end to the inside end, so that the first shaft part is sequentially sleeved on an oil sealing washer and an oil sealing ring and abutted on the second shaft part, and a rotary joint with a screw thread on the outer side thereof is provided with a first coupling part and a second coupling part for coupling of the first shaft part and second shaft part, and also the oil sealing washer and the oil sealing ring are tightly fitted in the second coupling part, and then the rotary joint can be rotatably embedded in the joint.

2. The joint structure of high pressure grease gun tubing defined in claim 1, wherein a caulking groove is arranged inside the second shaft part of the joint, and a nesting part is arranged at the inside the rotary joint, so that the end of the nesting part is pressed and embedded in the caulking groove, so that the rotary joint can be rotated on the joint without falling out.
